(19) United States
(12) Patent Application Publication
(10) Pub. No.: US 2026/0260054 A1
(43) Pub. Date: Sep. 3, 2026

(54) GENERATING MACHINE-LEARNING BASED RECOMMENDATIONS FOR NEXT BEST ACTIONS IN DIGITAL CONTENT EDITING APPLICATIONS

(71) Applicant: Adobe Inc., San Jose, CA (US)

(72) Inventors: Tal Shoer, Woodinville, WA (US); Vipul Aggarwal, Noida (IN); Prateek Mishra, Noida (IN); Marina Mahtab, Bangalore (IN); Aniket Gupta, Delhi (IN); Anamika Upadhyay, Ghazipur (IN)

(21) Appl. No.: 19/066,677

(22) Filed: Feb. 28, 2025

(51) Int. Cl. G06F 40/166; G06F 3/0482

(52) U.S. Cl. CPC G06F 40/166; G06F 3/0482

(57) ABSTRACT

The present disclosure relates to systems, non-transitory computer-readable media, and methods for generating machine-learning based action recommendations for display on a client device. In particular, the disclosed systems generate, utilizing a context aware neural network, a first set of action recommendations for editing a digital document based on contextual data from content of the digital document. Additionally, the disclosed systems generate, utilizing a user persona model, a second set of action recommendations for editing the digital document based on user specific data of a user account editing the digital document. Further, the disclosed systems determine, utilizing an ensemble model, one or more selected action recommendations from the first set of action recommendations or the second set of action recommendations. Moreover, the disclosed systems provide, for display on a client device, the one or more selected action recommendations within a graphical user interface including the digital document.

### BACKGROUND

Recent years have seen significant improvements in hardware and software platforms for generating and modifying digital documents. For example, in the field of digital document editing, client devices often create digital designs in designing applications based on a series of user interactions with various user interfaces for adding, selecting, and manipulating objects of the digital document such as text, images, objects, etc. To illustrate, client devices generate digital documents such as digital fliers, banners, social media posts, posters, etc., based on addition, selection, and manipulation of various images, text fields, and/or visual property elements collectively referred to as a journey. Indeed, conventional systems have a number of drawbacks that negatively impact the flexibility, accuracy, and efficiency of in relation to ensuring completion of journeys via designing applications.

### SUMMARY

Embodiments of the present disclosure provide benefits and/or solve one or more of the foregoing or other problems in the art with systems, non-transitory computer-readable media, and methods for generating dynamic, ensemble machine-learning based recommendations of next best actions for editing digital documents in content editing applications. In particular, the disclosed systems generate intelligent machine learning model-based action recommendations for designing digital documents such as fliers, posters, social media posts, etc. For example, the disclosed systems utilize machine learning models to dynamically generate action recommendations to perform specific actions and/or use specific tools throughout the design process. Indeed, in some embodiments, the disclosed systems utilize machine learning models to dynamically generate a set of action recommendations based on contextual data, user specific data, and/or successful journey data as the design journey progresses. Further, the disclosed systems utilize an ensemble machine learning model to leverage recommendations based on the contextual data, user specific data, and successful journey data by selecting the most relevant recommendations generated by the machine-learning models for display on a client device (e.g., via an editing platform).

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an action recommendation system operates in accordance with one or more embodiments.

FIG. 2 illustrates an overview diagram of the action recommendation system generating action recommendations for display in a graphical user interface utilizing machine learning models in accordance with one or more embodiments.

FIG. 3 illustrates a diagram of the action recommendation system generating context action recommendations utilizing a context aware neural network in accordance with one or more embodiments.

FIG. 4 illustrates a diagram of the action recommendation system generating persona action recommendations utilizing a persona model in accordance with one or more embodiments.

FIG. 5 illustrates a diagram of the action recommendation system generating journey action recommendations utilizing a journey model in accordance with one or more embodiments.

FIG. 6 illustrates a diagram of the action recommendation system determining selected action recommendations utilizing an ensemble model in accordance with one or more embodiments.

FIG. 7 illustrates a diagram of the action recommendation system displaying selected action recommendations in example graphical user interfaces in accordance with one or more embodiments.

FIG. 8 illustrates an example schematic diagram of the action recommendation system in accordance with one or more embodiments.

FIG. 9 illustrates a flowchart of an example series of acts for generating machine-learning based action recommendations for display on a client device via an ensemble model in accordance with one or more embodiments.

FIG. 10 illustrates a block diagram of an example computing device for implementing one or more embodiments of the present disclosure.

### DETAILED DESCRIPTION

This disclosure describes one or more embodiments of an action recommendation system that generates dynamic, machine-learning based action recommendations for editing digital documents in content editing applications via an ensemble model. Specifically, the action recommendation system utilizes a context aware neural network to generate action recommendations based on contextual data of a digital document being edited such as a flyer, poster, social media post, etc. Moreover, in some implementations, the action recommendation system utilizes a persona model to generate action recommendations based on user specific data of a user account editing the digital document. Furthermore, in one or more embodiments, the action recommendation system utilizes a journey model to generate action recommendations related to a successful journey for editing the digital document. Additionally, in one or more implementations, the action recommendation system determines a selected set of action recommendations from the action recommendations generated via the context aware neural network, the persona model, and the journey model using an ensemble model.

As mentioned above, in some embodiments, the action recommendation system utilizes a context aware neural network to generate action recommendations based on contextual data of a digital document being edited. In particular, the action recommendation system utilizes the context aware neural network to generate the context action recommendations based on project, session, and/or canvas data associated with the digital document for each click/action taken on the digital document. Further, in some implementations, the action recommendation system generates the context action recommendations based on an action history of edits to the digital document.

In one or more embodiments, the action recommendation system utilizes a persona model to generate action recommendations based on user specific data of a user account editing the digital document. Specifically, the action recommendation system utilizes the persona model to generate persona action recommendations based on a user persona of a user account editing the digital document. Moreover, in one or more implementations, the action recommendation system utilizes the persona model to generate the persona action recommendations based on a set of edits most relevant to the user account.

In some embodiments, the action recommendation system utilizes a journey model to generate action recommendations related to successful journeys for editing the digital document. In particular, the action recommendation system utilizes the journey model to generate the journey action recommendations based on a tenure/experience level of the user account with the editing platform. Furthermore, in some implementations, the action recommendation system generates the journey action recommendations based on a purpose of the digital document and/or a journey starting point of editing the digital document in relation to one or more possible successful journeys.

In one or more additional embodiments, the action recommendation system determines a selected set of action recommendations from the action recommendations generated via the context aware neural network, the persona model, and the journey model using an ensemble model. Specifically, the action recommendation system utilizes the ensemble model to assign weights to the context, persona, and journey action recommendations. In one or more implementations, based on these weights, the action recommendation system selects a subset of action recommendations from the context, persona, and journey action recommendations for display in the editing platform on a client device.

Although conventional systems are capable of generating and modifying digital design documents, such systems have a number of problems in relation to flexibility of operation, accuracy, and efficiency. For instance, conventional systems demonstrate operational inflexibility by failing to provide any recommendations for next edits or providing only static recommendations. Specifically, these conventional systems that provide static recommendations do so based solely on the type of object selected within a canvas of a design application. To illustrate, these conventional systems provide the same image editing recommendations each time an image of the design is selected, or the same set of text editing recommendations each time a text object is selected. Thus, these conventional systems lack the flexibility to provide dynamic action recommendations.

In addition to their operational inflexibility, conventional systems inaccurately provide recommendations of next actions. As explained above, conventional systems that do provide next action recommendations do so based solely on the type of object selected. Such conventional systems fail to account for any other context when determining which recommendations to provide. Thus, the recommendations provided often inaccurately reflect the actual next actions needed for the design project to progress. Such inaccuracy frequently leads to the recommendations being ignored.

In addition to their inflexibility and inaccuracies, conventional systems inefficiently provide relevant graphical user interface tools during editing of design documents. More specifically, conventional systems require more interactions to select and display the relevant actions or tools for performing an action. For example, conventional systems that fail to provide recommendations or provide recommendations inaccurate to an actual next best action require more user interactions to navigate to and select the graphical user interface tools needed to perform the next action (e.g., by requiring a user to navigate through several menus or tool panes).

As suggested by the foregoing, embodiments of the action recommendation system provide a variety of improvements relative to conventional systems. For example, by providing dynamic action recommendations based on user account and digital document specific data, the action recommendation system improves flexibility relative to conventional systems. In particular, by generating context action recommendations, persona action recommendations, and journey action recommendations, the action recommendation system generates dynamically changing action recommendations specific to the user account, the digital document, and the progress made in the editing journey of the digital document. Additionally, in some embodiments, by utilizing an ensemble model to select the most relevant recommendations of the context, persona, and journey action recommendations for display after each action, the action recommendation system provides continuously updating (i.e., real time) action recommendations throughout the editing journey. Thus, the action recommendation system holistically and comprehensively adapts the action recommendations at any given point in time to the editing journey of the specific user account in the specific digital document.

Further, by flexibly generating action recommendations adapted to a given point in time in the editing journey of the specific user account in the specific digital document, the action recommendation system improves accuracy relative to conventional systems. Specifically, by generating and selecting a set of action recommendations from context, persona, and journey recommendations, the action recommendation system provides action recommendations that accurately reflect actual next edits needed to complete the editing journey. Indeed, by generating and providing intelligent (e.g., machine learning-based) action recommendations, the action recommendation system provides action recommendations accurate to next best actions along the editing journey that lead to a completed digital document ready for export.

Moreover, by reducing the number of interactions and/or interfaces required to perform next actions, the action recommendation system improves efficiency relative to conventional systems. In particular, the action recommendation system provides flexible and accurate action recommendations throughout the editing journey as just described. For example, the action recommendation system provides these action recommendations as interactive graphical elements within the graphical user interface used for editing the digital document. Indeed, the action recommendation system provides interactive graphical elements as recommendations selectable for the user account in a single interaction on a single graphical user interface to perform the next action. Thus, the action recommendation system prevents the need for navigating through a series of interactions, menus, and/or user interfaces to perform an editing action or select a tool for performing the next action.

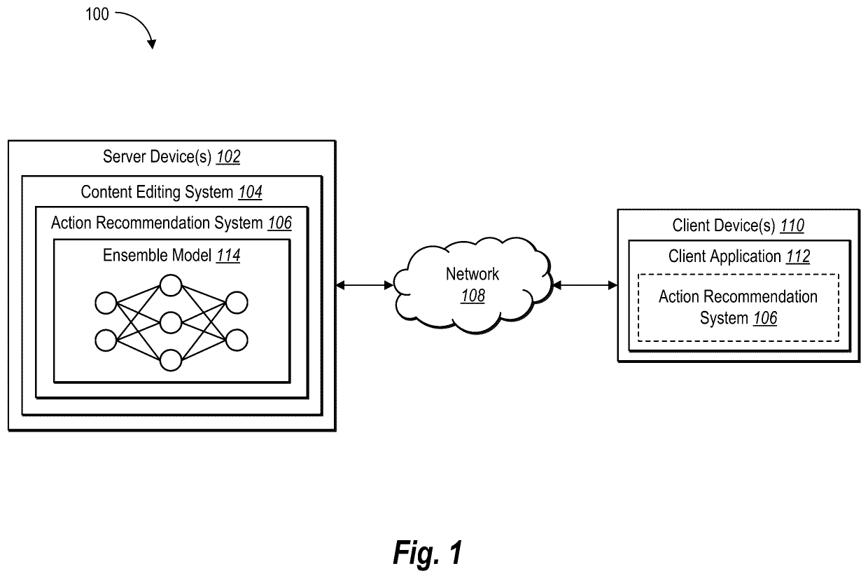

Additional detail regarding the action recommendation system 106 will now be provided with reference to the figures. For example, FIG. 1 illustrates a schematic diagram of a system environment 100 in which an action recommendation system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the action recommendation system 106 via the network 108). Similarly, although FIG. 1 illustrates a particular arrangement of the server device(s) 102, the network 108, and the client device(s) 110, various additional arrangements are possible.

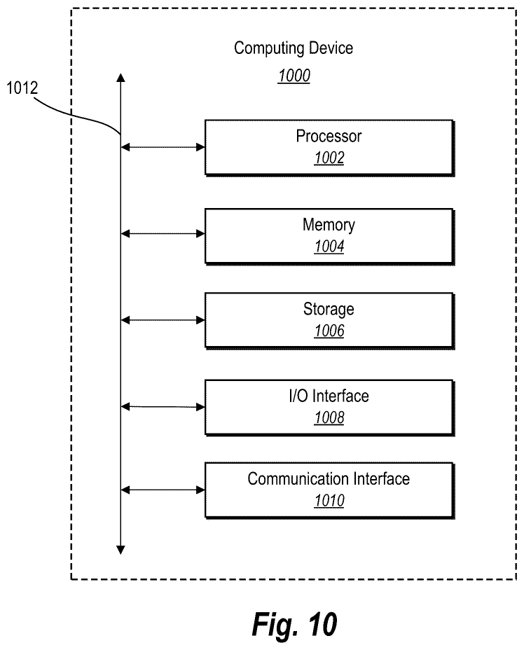

The server device(s) 102, the network 108, and the client device(s) 110 are communicatively coupled with each other either directly or indirectly (e.g., through the network 108 discussed in greater detail below in relation to FIG. 10). Moreover, the server device(s) 102 and the client device(s) 110 include one or more of a variety of computing devices (including one or more computing devices as discussed in greater detail with relation to FIG. 10).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits digital documents. For example, in some instances, a client device sends a digital document to the content editing system 104 hosted on the server device(s) 102 via the network 108. The content editing system 104 provides options usable by the client device to edit the digital documents, store the digital documents, and subsequently search for, access, and view the digital documents. To illustrate, the content editing system 104 provides one or more options that are usable by the client device to design digital document based on selected action recommendations that are dynamically updated utilizing machine learning models.

As further shown, the server device(s) 102 also include the action recommendation system 106 for accessing machine learning models (e.g., the ensemble model 114) to generate and select action recommendations for display in the content editing system 104. In one or more embodiments, the action recommendation system 106 generates context action recommendations, persona action recommendations, and journey action recommendations utilizing various machine learning models. Furthermore, as will be explained below, the action recommendation system 106 accesses the ensemble model to determine selected action recommendations from the context, persona, and journey action recommendations. Additionally, the action recommendation system 106 provides the selected action recommendations for display within a graphical user interface of an editing platform on a client device.

As illustrated in FIG. 1, the action recommendation system 106 includes an ensemble model 114. Indeed, in these or other embodiments, the action recommendation system 106 accesses the ensemble model 114 to determine sets of weights for the context, persona, and journey action recommendations. Further, the ensemble model determines the selected action recommendations for display in the graphical user interface of the editing platform based on the weights. In some cases, the ensemble model 114 is external to the action recommendation system 106, but the action recommendation system 106 nevertheless accesses and utilizes the ensemble model 114 via one or more plugins, APIs, or other network-based access protocols.

In some embodiments, the ensemble model 114 includes a machine learning model trained and/or tuned based on inputs to approximate unknown functions. For example, the ensemble model 114 includes a computer algorithm with branches, weights, or parameters that change based on training data to improve for a particular task. Thus, the ensemble model 114 utilizes one or more learning techniques (e.g., supervised or unsupervised learning) to improve in accuracy and/or effectiveness. Example ensemble models include various types of decision trees or neural networks (e.g., deep neural networks, generative adversarial neural networks, convolutional neural networks, recurrent neural networks, or diffusion neural networks).

In one or more embodiments, the client device(s) 110 includes a computing device that accesses, edits, segments, modifies, stores, and/or provides, for display, digital content such as digital documents and selected action recommendations for next best actions for editing the digital documents. For example, in some embodiments, the client device(s) 110 includes a smartphone, a tablet, a desktop computer, a laptop computer, a head-mounted-display device, or another electronic device, including those explained below with reference to FIG. 10. In some instances, the client device(s) 110 includes one or more applications (e.g., a client application 112) that access, edit, segment, modify, store, and/or provide, for display, digital content such as digital documents and selected action recommendations for next best actions for editing the digital documents. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicate via the network using one or more communication platforms and technologies suitable for transporting data and/or communication signals, including any known communication technologies, devices, media, and protocols supportive of data communications, examples of which are described with reference to FIG. 10.

To provide an example implementation, in some embodiments, the action recommendation system 106 on the server device(s) 102 supports the action recommendation system 106 on the client device(s) 110. For instance, in some cases, the action recommendation system 106 on the server device(s) 102 generates or learns parameters for the ensemble model 114. The action recommendation system 106 then, via the server device(s) 102, provides the ensemble model 114 to the client device(s) 110. In other words, the client device(s) 110 obtains (e.g., downloads) the ensemble model 114 from the server device(s) 102. Once downloaded, the action recommendation system 106 on the client device(s) 110 uses the ensemble model 114 to determine selected action recommendations for next best editing actions for display on the client device(s) 110 independent of the server device(s) 102. In some implementations, the action recommendation system 106 generates or learns parameters for the ensemble model 114 on the client device(s) 110.

In alternative implementations, the action recommendation system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a digital document being edited by a user account within an editing platform. In response, the action recommendation system 106 on the server device(s) 102 determines selected action recommendations for next best editing actions for editing the digital document (e.g., using the ensemble model). The server device(s) 102 then provides the selected action recommendations to the client device(s) 110 for display and/or further processing.

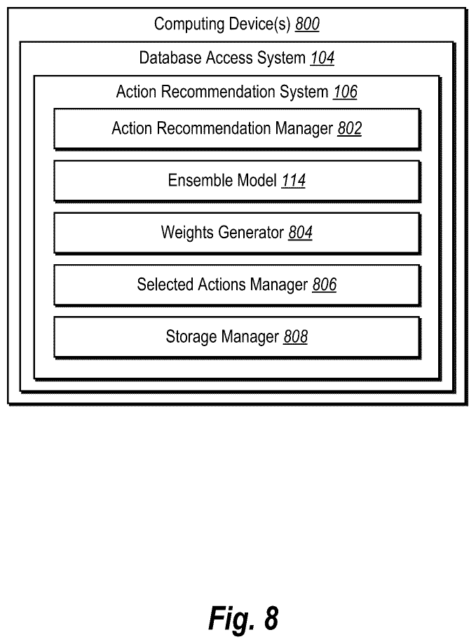

Although FIG. 1 illustrates the action recommendation system 106 implemented with regard to the server device(s) 102, different components of the action recommendation system 106 are able to be implemented by a variety of devices within the system environment 100. For example, in some instances, a different computing device (e.g., the client device(s) 110) or a separate server from the server device(s) 102 implements one or more (or all) components of the action recommendation system 106. Indeed, as shown in FIG. 1, the client device(s) 110 includes the action recommendation system 106. Example components of the action recommendation system 106 will be described below with regard to FIG. 8.

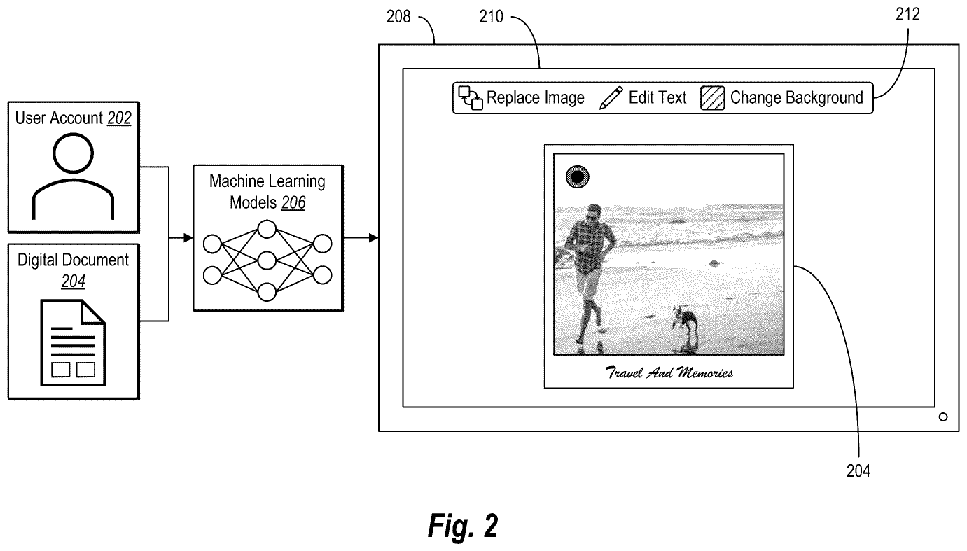

As previously mentioned, in some implementations, the action recommendation system 106 generates machine-learning based action recommendations for editing digital documents in content editing applications. For example, FIG. 2 illustrates an overview diagram of the action recommendation system 106 generating action recommendations for display in a graphical user interface utilizing machine learning models in accordance with one or more embodiments.

As illustrated in FIG. 2, in one or more embodiments, the action recommendation system 106 utilizes data of a user account 202 associated with an editing platform. In one or more implementations, a user account includes a digital identity created and maintained within a system or platform (e.g., an editing platform). Specifically, a user account includes associated data, metadata, permissions, persona information, content history, editing history, etc., enabling personalized access and interaction with the platform's features and services. In some embodiments, the action recommendation system 106 accesses the user account 202 and associated data for generating action recommendations.

Relatedly, an editing platform refers to a digital tool or application that provides user accounts with the ability to create, modify, and customize visual and/or textual content. For example, an editing platform allows a user account to access and utilize design templates, interactive tools, and collaborative capabilities to produce digital documents such as images, fliers, posters, social media posts, and other design documents. In some implementations, the action recommendation system 106 accesses data of the editing platform such as the types of edits available in the platform and interfaces with the platform to provide selected action recommendations for display in a graphical user interface of the editing platform.

As further illustrated in FIG. 2, in one or more embodiments, the action recommendation system 106 utilizes data associated with a digital document 204 being edited by the user account 202 on the editing platform. In one or more implementations, a digital document includes an electronic file or electronic content that contains text, images, multimedia elements, etc., and is created, edited, shared, or stored using digital devices or software (e.g., the editing platform). For example, a digital document includes a wide variety of file types and formats generated using various applications tailored for specific purposes, such as graphic design software. For example, a digital document includes electronic files or content created to serve as fliers, posters, and social media posts, etc. In some embodiments, the action recommendation system 106 accesses data (e.g., metadata) associated with the digital document 204 to determine a purpose of the digital document 204, editing history of the digital document 204, etc.

As additionally shown in FIG. 2, in some implementations, the action recommendation system 106 utilizes the data from the user account 202 and the digital document 204 with machine learning models 206 to generate action recommendations for editing the digital document 204 on the editing platform. In one or more embodiments, an action recommendation includes a recommendation to perform an action editing a digital document. In particular, an action recommendation includes recommendations for editing content of a digital document such as adding content, removing content, modifying content, replacing content, relocating content within the document, or any other editing function of an editing platform (e.g., editing application).

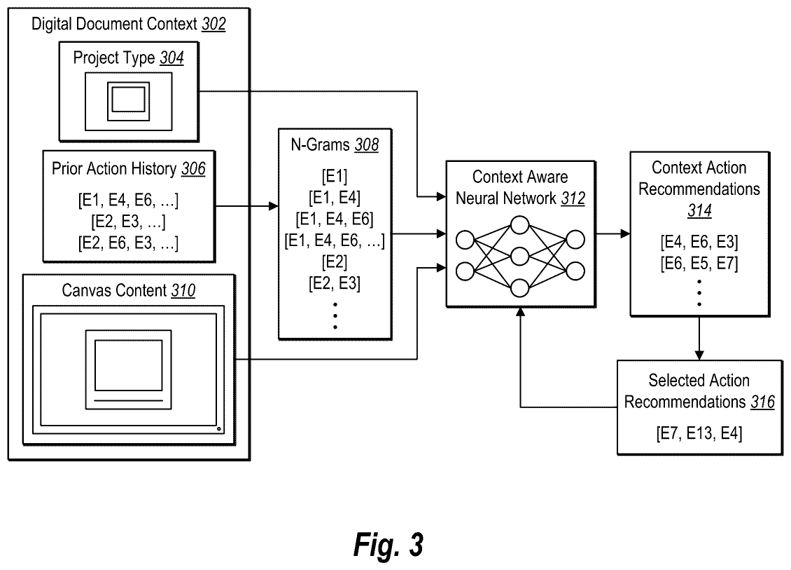

As previously noted, the action recommendation system 106 utilizes machine learning models 206 to generate action recommendations based on user account 202 and digital document 204 data. Specifically, the action recommendation system 106 utilizes a context aware neural network to generate action recommendations based on contextual data from content of the digital document 204. Moreover, in one or more implementations, the action recommendation system 106 utilizes a persona model to generate action recommendations based on user specific data of the user account 202 editing the digital document 204. Furthermore, in some embodiments, the action recommendation system 106 utilizes a journey model to generate action recommendations related to successful journeys for editing the digital document 204 on the editing platform. Additional detail regarding generating action recommendations utilizing the context aware neural network, the persona model, and the journey model is provided with respect to FIGS. 3, 4, and 5, respectively.

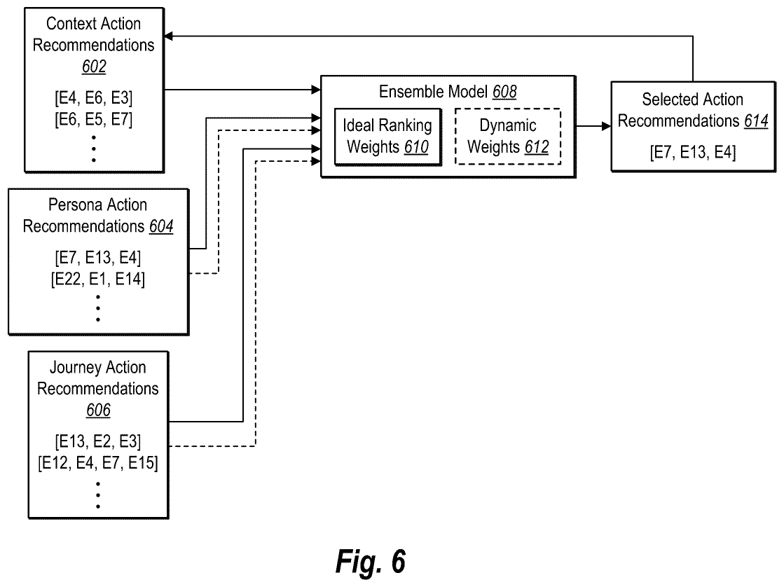

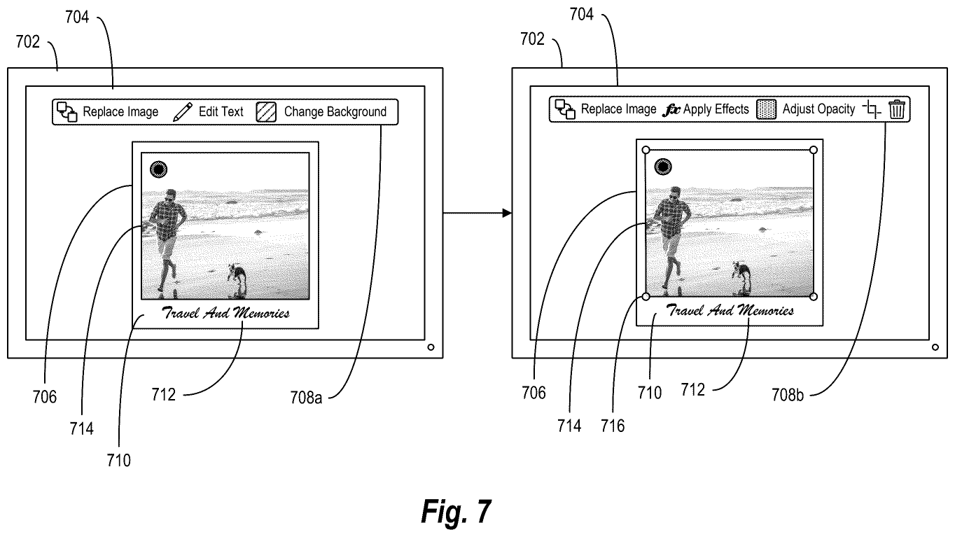

Additionally, in some implementations, the action recommendation system 106 utilizes the machine learning models 206 to determine selected action recommendations 212 for display on the editing platform. In particular, the action recommendation system 106 utilizes an ensemble model (e.g., ensemble model 114 of FIG. 1) to determine the selected action recommendations 212 as further detailed with respect to FIG. 6. Further, in one or more embodiments, the action recommendation system 106 provides the selected action recommendations 212 for display in a graphical user interface 210 of a client device 208 displaying the digital document 204. Additional detail regarding displaying the selected action recommendations 212 in the graphical user interface 210 is provided with respect to FIG. 7.

As mentioned above, in one or more implementations, the action recommendation system 106 utilizes a context aware neural network to generate action recommendations based on contextual data of a digital document being edited. FIG. 3 illustrates a diagram of the action recommendation system 106 generating context action recommendations utilizing a context aware neural network in accordance with one or more embodiments.

As shown in FIG. 3, in some embodiments, the action recommendation system 106 utilizes digital document context 302 to generate context action recommendations 314. Specifically, the action recommendation system 106 utilizes contextual data from the digital document (e.g., digital document 204 of FIG. 2) such as a project type 304 of the digital document. For example, the action recommendation system 106 accesses the digital document to determine the project type 304 from data of the digital document. To illustrate, the action recommendation system 106 determines a project type indicating whether the document is intended as a social media post, a flyer, a poster, an informational document, etc.

As further illustrated in FIG. 3, in some implementations, the action recommendation system 106 utilizes contextual data such as a prior action history 306 from the content of the digital document to generate the context action recommendations 314. In particular, the action recommendation system 106 utilizes the prior action history 306 of edits (e.g., editing actions) to the digital document. For example, the action recommendation system 106 determines edits of the digital document in a current session and/or prior sessions of editing the digital document. In these or other embodiments, the action recommendation system 106 determines the edits up to the point of generating the context action recommendations 314.

To illustrate, in one or more embodiments, the action recommendation system 106 determines the edits of the prior action history 306 including sets of edits or a series of edits. For example, the action recommendation system 106 determines edits in the current session such as adding an image, editing dimensions of the image, adding a background to the image, adding a text object, adding and modifying text to the object, etc. As illustrated in FIG. 3, these edits are represented by particular edit numbers such as Edit 1 (E1), Edit 2 (E2), etc. In these or other embodiments, the action recommendation system 106 determines prior edits including the order in which the edits were performed up to the point of generating the context action recommendations 314.

Moreover, in one or more implementations, the action recommendation system 106 determines a sliding window of edits of the prior action history 306. For example, in some embodiments, the action recommendation system 106 determines all the edits of the prior action history 306 for use in generating the context action recommendations 314. Furthermore, in some implementations, the action recommendation system 106 determines the edits of the prior action history 306 up to a threshold number (e.g., 100 past edits). In these or other embodiments, after surpassing this threshold number, the action recommendation system 106 determines a sliding window of past edits equal to the threshold number to include the latest edits and excluding the oldest edits.

Additionally, in one or more embodiments, the action recommendation system 106 utilizes only meaningful prior actions (e.g., based on a set of pre-identified meaningful actions) and not every action that occurs during editing of the digital document. For example, in one or more implementations, the set of meaningful actions includes changing a background color of the digital document. In another example, the set of meaningful events includes relocating an image over a threshold distance or number of pixels (e.g., from the top right to the center of the canvas but not moving the image by only 3 pixels).

As also depicted in FIG. 3, in some embodiments, the action recommendation system 106 generates n-grams 308 of edits based on the prior action history 306. Specifically, the action recommendation system 106 determines a sequence of events including prior actions (e.g., edits) performed in the digital document. Further, in some implementations, the action recommendation system 106 generates the n-grams 308 from the prior actions. To illustrate, based the prior action history 306 including past edits E1, E4, E6, the action recommendation system 106 generates the n-grams [E1], [E1, E4], and [E1, E4, E6].

Moreover, in one or more embodiments, the action recommendation system 106 pads the n-grams 308. In particular, the action recommendation system 106 pads the n-grams 308 to ensure the n-grams have equal lengths. For instance, the action recommendation system 106 generates and pads the n-grams to generate the context action recommendations 314 utilizing a context aware neural network 312 (e.g., of the machine learning models 206 of FIG. 2) or as part of training the context aware neural network 312.

As further illustrated in FIG. 3, in one or more implementations, the action recommendation system 106 utilizes contextual data from the content of the digital document such as canvas content 310 to generate the context action recommendations 314. Specifically, the action recommendation system 106 utilizes the content of a canvas of the digital document such as when the digital document is displayed in an editing application in a graphical user interface of a client device. For example, the action recommendation system 106 determines canvas content 310 such as objects and/or object types that are available and/or selected, or unavailable on a canvas of the digital document.

To illustrate, in some embodiments, the action recommendation system 106 determines that a canvas of the digital document includes a background layer, an uploaded image, and a text object all available (e.g., available for selection and editing) on the canvas. In some implementations, the action recommendation system 106 determines the context action recommendations 314 based on these available objects on the canvas. Additionally, or alternatively, the action recommendation system 106 determines a selected object on the canvas and utilizes the selection of the object (e.g., the selection of an image) to generate the context action recommendations 314. Furthermore, in one or more embodiments, the action recommendation system 106 determines objects that are not available (e.g., a video) and generates the context action recommendations 314 based on what objects are not available on the canvas (i.e., what objects need to be added to the digital document).

As additionally shown in FIG. 3, in one or more implementations, the action recommendation system 106 generates the context action recommendations utilizing a context aware neural network 312. In particular, the action recommendation system 106 utilizes the project type 304, the prior action history 306, the n-grams 308, and/or the canvas content 310 with the context aware neural network 312 to generate the context action recommendations 314. To illustrate, the action recommendation system 106 accesses the context aware neural network 312 and provides the digital document context 302 and/or n-grams to the context aware neural network 312 to generate the context action recommendations 314.

In some embodiments, the context aware neural network 312 includes a machine learning model trained and/or tuned based on inputs to determine next best actions for editing a digital document based on contextual data of the digital document. For example, the context aware neural network includes a neural network of interconnected artificial neurons (e.g., organized in layers) that communicate and learn to approximate complex functions and generate outputs (e.g., context action recommendations) based on a plurality of inputs provided to the neural network. In some cases, a context aware neural network refers to a computer process that implements deep learning techniques to model high-level abstractions in data. In some implementations, a context aware neural network includes various layers such as a long short-term memory (LSTM) layer or other recurrent neural network layer and a separate dense layer.

In one or more embodiments, the context action recommendations 314 include recommendations for editing the digital document. Specifically, the context action recommendations 314 include recommendations that are most likely to improve the digital document to progress the digital document toward completion. In these or other embodiments, the context action recommendations 314 include a set of recommendations for the next best editing actions available based on the contextual data of the digital document. To illustrate, in one or more implementations, the action recommendation system 106 generates sets of context action recommendations 314 such as a first set including first set including edit 4 (E4), edit 6 (E6), and edit 3 (E3), a second set including edit 6 (E6), edit 5 (E5), and edit 7 (E7), etc.

As further illustrated in FIG. 3, in some embodiments, the action recommendation system 106 determines selected action recommendations 316. In particular, the action recommendation system 106 determines the selected action recommendations 316 based, at least in part, on the context action recommendations 314 as discussed further with respect to FIG. 6. Additionally, in some implementations, the action recommendation system 106 updates the context action recommendations based on a performed action corresponding to a selected action recommendation 316.

To illustrate, the action recommendation system 106 detects a performance of an action corresponding to one of the selected action recommendations 316. Further, the action recommendation system 106 utilizes the performed action (e.g., the latest edit of the digital document) with the context aware neural network 312 to update the context action recommendations 314. Specifically, in one or more embodiments, the action recommendation system 106 adds the performed action to the prior action history 306, updates the n-grams 308 as needed, and utilizes the context aware neural network 312 to generate an updated set of context action recommendations 314. In one or more implementations, in a similar manner, the action recommendation system 106 alternatively updates the context action recommendations 314 based on a performed action that does not correspond to the selected action recommendations 316 but still represents the latest edit to the digital document.

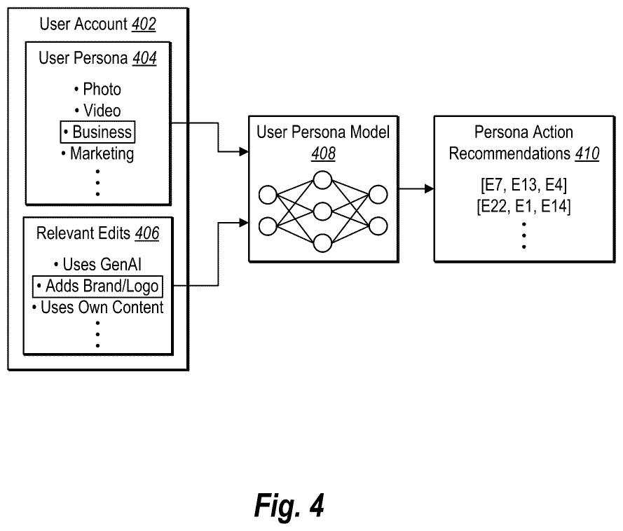

As noted above, in some embodiments, the action recommendation system 106 generates action recommendations based on user specific data of a user account editing the digital document. Indeed, in some implementations, the action recommendation system 106 generates these persona action recommendations utilizing a persona model. FIG. 4 illustrates a diagram of the action recommendation system 106 generating persona action recommendations utilizing a persona model in accordance with one or more embodiments.

As portrayed in FIG. 4, in one or more embodiments, the action recommendation system 106 utilizes user specific data of a user account 402 (e.g., user account 202 of FIG. 2) editing the digital document (e.g., digital document 204 of FIG. 2) to generate persona action recommendations 410. In particular, the action recommendation system 106 utilizes a user persona 404 corresponding to the user account 402 to generate the persona action recommendations 410. For example, the action recommendation system 106 accesses the user account 402 and determines the user persona 404 based on the data of the user account 402.

As just mentioned, the action recommendation system 106 determines the user persona 404 based on data from the user account 402. Specifically, in one or more implementations, the action recommendation system 106 determines the user persona 404 based on the project types associated with the user account 402. For example, the action recommendation system 106 determines categories of project types associated with the user account and determines the user persona based on the categories of project types. In some embodiments, the action recommendation system 106 determines the user persona by determining a primary category associated with a majority of user projects of similar user accounts (e.g., according to user demographics), a majority of recent user projects, or other data.

To illustrate, the action recommendation system 106 determines that a user persona 404 of the user account 402 is a ‘photo’ user based on determining that the primary project types associated with the user account 402 include photo editing. In another example, the action recommendation system 106 determines that the user persona 404 is ‘business’ or ‘marketing’ based on determining that the primary project types of the user account 402 include business or marketing projects, respectively. Indeed, the action recommendation system 106 determines the user persona 404 which includes any number of categories such as ‘photo’, ‘video’, ‘business’, ‘marketing’, ‘education’, etc. Accordingly, in one or more embodiments, the user persona 404 provides a brief description of typical use cases of the user account 402 in connection with an editing application.

As also depicted in FIG. 4, in some implementations, the action recommendation system 106 utilizes relevant edits 406 to generate the persona action recommendations 410. In particular, the action recommendation system 106 determines the relevant edits 406 by determining a set of edits relevant to the user account 402 based on a project history of the user account. For instance, the action recommendation system 106 determines the most relevant edits to the user account 402 utilizing a singular value decomposition model.

As just mentioned, the action recommendation system 106 utilizes a singular value decomposition model to determine the most relevant edits to the user account 402. Specifically, the action recommendation system 106 utilizes the singular value decomposition model as a collaborative filtering technique. For example, the action recommendation system 106 utilizes the singular value decomposition model to produce the most relevant recommendations by reducing the number of features of a dataset. In particular, the singular value decomposition model reduces the number of features of the dataset by reducing the space dimension form N-dimension to K-dimension where K<N.

In one or more embodiments, the action recommendation system 106 utilizes a matrix structure of the user account project history as the dataset for the singular value decomposition model. Specifically, a row of the matrix represents the user account 402 and each column represents an edit action. For example, the action recommendation system 106 utilizes a matrix generated from the edit actions of the user account 402 across the projects or a subset of the projects associated with the user account 402. In these or other embodiments, the elements of the matrix represent a frequency of editing sessions wherein the user account 402 used an edit action as part of creating a project. In additional embodiments, the action recommendation system 106 utilizes a matrix structure including a plurality of rows representing a plurality of user accounts with columns representing the corresponding edit actions.

In one or more implementations, the action recommendation system 106 determines a set of characteristics of the user account 402 utilizing the singular value decomposition model from the edit actions in the matrix. To illustrate, the action recommendation system 106 determines characteristics such as “uses GenAI” (i.e., uses generative artificial intelligence), “adds Brand/Logo”, “uses own content”, “uses resize QA”, “interacts with social media projects”, etc. In these or other embodiments, the action recommendation system 106 utilizes these characteristics to determine the relevant edits 406.

Moreover, in some embodiments, the action recommendation system 106 recursively determines the relevant edits 406. In particular, the action recommendation system 106 redetermines the relevant edits 406 after a time threshold. For instance, the action recommendation system 106 determines the relevant edits 406 every 24 hours, one time per week, or other timeframe relevant to the user account 402. Alternatively, in some implementations, the action recommendation system 106 determines the relevant edits after the time threshold only if the action recommendation system 106 determines that some activity has occurred for the user account within the previous time threshold.

As further illustrated in FIG. 4, in one or more embodiments, the action recommendation system 106 utilizes a user persona model 408 (e.g., of the machine learning models 206 of FIG. 2) to generate the persona action recommendations 410. Specifically, the action recommendation system 106 utilizes the user persona 404 and the relevant edits 406 with the user persona model 408 to generate the persona action recommendations 410. For example, the action recommendation system 106 accesses the user persona model 408 and provides the user persona 404 and/or the relevant edits 406 to the persona model 408 to generate the persona action recommendations 410 for editing the digital document.

To illustrate, the action recommendation system 106 utilizes the persona model 408 to generate persona action recommendations 410 for next edits in the digital document. For instance, the action recommendation system 106 generates persona action recommendations 410 including sets of edits such as a first set including edit 7 (E7), edit 13 (E13), and edit 4 (E4), a second set including edit 22 (E22), edit 1 (E1), and edit 14 (E14), etc.

In one or more implementations, the user persona model 408 includes a machine learning model trained and/or tuned based on inputs to approximate unknown functions. For example, a user persona model includes a computer algorithm with branches, weights, or parameters that change based on training data to improve for a particular task. Thus, a user persona model utilizes one or more learning techniques (e.g., supervised or unsupervised learning) to improve in accuracy and/or effectiveness. As mentioned, in one or more embodiments, the user persona model 408 utilizes a singular value decomposition model for collaborative filtering. In other embodiments, example user persona models include various types of decision trees or neural networks (e.g., deep neural networks, generative adversarial neural networks, convolutional neural networks, recurrent neural networks, or diffusion neural networks).

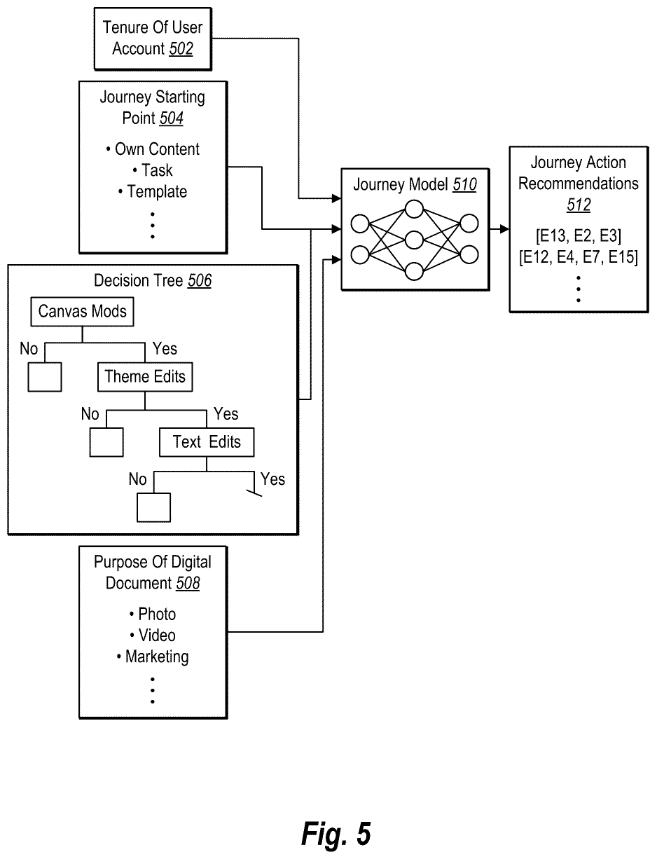

As mentioned previously, in some embodiments, the action recommendation system 106 generates action recommendations related to successful journeys for editing the digital document. Indeed, in some implementations, the action recommendation system 106 utilizes a journey model to generate these journey action recommendations. FIG. 5 illustrates a diagram of the action recommendation system 106 generating journey action recommendations utilizing a journey model in accordance with one or more embodiments.

As depicted in FIG. 5, in one or more embodiments, the action recommendation system 106 utilizes a tenure 502 of the user account (e.g., user account 202 of FIG. 2) to generate journey action recommendations 512 related to a successful journey for editing the digital document (e.g., digital document 204 of FIG. 2) within an editing platform. In particular, the action recommendation system 106 determines the tenure 502 for the user account within the editing platform by accessing the user account data and determining an experience level of the user account. For example, the action recommendation system 106 determines the tenure 502 based on an amount of time since creation or first use of the user account within the editing platform.

To illustrate, the action recommendation system 106 determines the tenure 502 by accessing the user account editing the digital document and determining that an experience level of the user account is a day 1 (or first time) user, a day 2-7 (or returning) user, a day 7-28 user, or a day 28+ (habitual) user. Additionally, or alternatively, the action recommendation system 106 determines the experience level based on other time frames and/or other tenure factors such as a number and/or complexity of projects completed by the user, etc.

As additionally shown in FIG. 5, in one or more implementations, the action recommendation system 106 utilizes a journey starting point 504 to generate the journey action recommendations 512. Specifically, the action recommendation system 106 determines the journey starting point 504 for the digital document. For example, the action recommendation system 106 determines the journey starting point based on an initial action performed in the digital document by the user account. To illustrate, the action recommendation system 106 determines an initial action such as adding the own content of the user account, clicking on a task, clicking on a template, visiting a Search Engine Optimization page, etc.

As further illustrated in FIG. 5, in some embodiments, the action recommendation system 106 utilizes a journey model 510 to generate a decision tree(s) 506 for use in combination with the journey starting point 504. In some embodiments, the journey model 510 includes a machine learning model trained and/or tuned based on inputs to approximate unknown functions. For example, the journey model 510 includes a computer algorithm with branches, weights, or parameters that change based on training data to improve for a particular task. Thus, a journey model utilizes one or more learning techniques (e.g., supervised or unsupervised learning) to improve in accuracy and/or effectiveness. Example journey models include or utilize various types of decision trees.

As mentioned above, in some embodiments, the action recommendation system 106 utilizes the journey model 510 to generate the decision tree(s) 506. Specifically, the action recommendation system 106 determines a successful journey pathway of actions based on the journey starting point 504 using the decision tree(s) 506. For example, the action recommendation system 106 generates the decision tree(s) 506 of the decision tree model by extracting pathways of editing actions leading to increased export rates across a plurality of user accounts of the editing platform.

In some implementations, the action recommendation system 106 extracts the pathways based on action flags utilizing the decision tree model. Specifically, the action recommendation system 106 generates each of the decision tree(s) 506 to represent unique journeys from a single journey starting point. In these or other embodiments, the action recommendation system 106 utilizes the decision tree model to predict the actions that demarcate successful journeys (e.g., resulting in export) from unsuccessful journeys. Furthermore, in these or other embodiments, the action recommendation system 106 extracts the pathways of editing actions of successful and unsuccessful journeys from the plurality of user accounts of the editing platform.

In these or other embodiments, each starting point 504 corresponds to at least one decision tree 506. Further, in these or other embodiments, each decision tree 506 includes a pathway of editing actions likely to progress the project to completion. For example, the action recommendation system 106 generates the pathways of editing actions of the decision tree(s) 506 based on prior editing journeys on the editing platform that result in export (e.g., by downloading, sharing, or other indicators of project completion).

To illustrate, the action recommendation system 106 determines the decision tree(s) 506 corresponding to the journey starting point 504. Further, the action recommendation system 106 generates the journey action recommendations 512 based on, at least in part, the journey starting point 504 and the decision tree(s) 506 506 utilizing the journey model 510. In these or other embodiments, the action recommendation system 106 generates journey action recommendations 512 that result in an increased export rate.

As also depicted in FIG. 5, in one or more embodiments, the action recommendation system 106 utilizes the purpose 508 of the digital document to generate the journey action recommendations 512. In particular, the action recommendation system 106 determines the purpose 508 of the digital document based on a primary medium included in the digital document or a content type of the digital document. For example, in these or other embodiments, the action recommendation system 106 determines the purpose 508 of the digital document by determining that the primary medium included in the digital document is photos, videos, text, etc. Additionally, or alternatively, in these or other embodiments, the action recommendation system 106 determines the content type of the digital document is business, marketing, educational, etc.

As further illustrated in FIG. 5, in one or more implementations, the action recommendation system 106 utilizes the journey model 510 to generate the journey action recommendations 512. Specifically, the action recommendation system 106 utilizes the journey model 510 with the tenure 502, the journey starting point 504 and the decision tree 506, and/or the purpose 508 to generate the journey action recommendations 512.

To illustrate, the action recommendation system 106 accesses the user account data, the digital document data, and/or the decision tree(s) 506. Moreover, the action recommendation system 106 generates and/or determines the tenure 502, the journey starting point 504, the decision tree(s) 506, and/or the purpose 508 and provides this information to the journey model 510 to generate the journey action recommendations 512. In this example, the action recommendation system 106 generates the journey action recommendations 512 for next edits in the digital document such as a first set including edit 13 (E13), edit 2 (E2), and edit 3 (E3), a second set including edit 12 (E12), edit 4 (E4), edit 7 (E7), and edit 15 (E15), etc.

As mentioned, the action recommendation system 106 generates the journey action recommendations 512 related to a successful journey for editing the digital document within the editing platform. In particular, as discussed above, the action recommendation system 106 determines successful journey data from editing action history of a plurality of accounts with access to the editing system. Thus, the action recommendation system 106 generates the journey action recommendations 512 to provide journey action recommendations that guide a user account through a successful editing journey from a first editing action to a last editing action before export (e.g., export via downloading or sharing the digital document).

As noted previously, in some implementations, the action recommendation system 106 determines a selected set of action recommendations from the action recommendations generated via the context aware neural network, the persona model, and the journey model. Indeed, in one or more embodiments, the action recommendation system 106 utilizes an ensemble model to determine the selected action recommendations for display in a graphical user interface of a client device. FIG. 6 illustrates a diagram of the action recommendation system 106 determining selected action recommendations utilizing an ensemble model in accordance with one or more embodiments.

As illustrated in FIG. 6, in one or more implementations, the action recommendation system 106 utilizes sets of action recommendations to determine selected action recommendations 614 (e.g., selected action recommendations 212 of FIG. 2) for display in a graphical user interface of a client device. Specifically, the action recommendation system 106 utilizes context action recommendations 602 (e.g., context action recommendations 314 of FIG. 3), persona action recommendations 604 (e.g., persona action recommendations 410 of FIG. 4), and/or journey action recommendations (e.g., journey action recommendations 512 of FIG. 5) to determine the selected action recommendations 614. For example, the action recommendation system 106 determines the selected action recommendations 614 based on weights assigned to the context action recommendations 602, the persona action recommendations 604, and the journey action recommendations 606.

As additionally shown in FIG. 6, in some embodiments, the action recommendation system 106 utilizes an ensemble model 608 (e.g., ensemble model 114 of FIG. 1) to generate the selected action recommendations 614. For example, the action recommendation system 106 utilizes an API call to cause the ensemble model 608 to generate a set of next actions. In particular, the action recommendation system 106 utilizes the ensemble model 608 to determine weights for the context action recommendations 602, the persona action recommendations 604, and the journey action recommendations 606. For example, the action recommendation system 106 utilizes the ensemble model 608 to determine ideal ranking weights 610 and/or dynamic weights 612.

As just mentioned, the action recommendation system 106 utilizes the ensemble model 608 to determine the ideal ranking weights 610. As further illustrated in FIG. 6, in some implementations, the action recommendation system 106 utilizes the ensemble model 608 with the context action recommendations 602, the persona action recommendations 604, and the journey action recommendations 606 to generate the ideal ranking weights 610. Specifically, the action recommendation system 106 generates the ideal ranking weights 610 by utilizing a ranking quality metric. For example, the action recommendation system 106 utilizes the ensemble model 608 to determine a normalized discounted cumulative gain to determine the ideal ranking weights 610.

To illustrate, the action recommendation system 106 determines the normalized discounted cumulative gain by comparing the context action recommendations 602, the persona action recommendations 604, and the journey action recommendations 606 to an ideal ranking. For example, the ideal ranking includes the context action recommendations 602, the persona action recommendations 604, and the journey action recommendations 606 sorted in descending order of relevance according to a ground truth. In other words, the ideal ranking includes the most relevant action recommendations of the context action recommendations 602, the persona action recommendations 604, and the journey action recommendations 606 at the top. In these or other embodiments, the action recommendation system 106 utilizes the ensemble model 608 to determine the normalized discounted cumulative gain at a given position by dividing the discounted cumulative gain by the ideal discounted cumulative gain (i.e., wherein the ideal discounted cumulative gain represents a perfect ranking).

As previously mentioned, in one or more embodiments, the action recommendation system 106 utilizes the ensemble model 608 to determine the dynamic weights 612. In particular, as also depicted in FIG. 6, the action recommendation system 106 utilizes the ensemble model 608 with the persona action recommendations 604 and the journey action recommendations 606 to generate the dynamic weights 612. For example, in one or more implementations, the action recommendation system 106 determines the dynamic weights 612 for the persona action recommendations 604 and the journey action recommendations 606 by determining the progress of the digital document (e.g., digital document 204 of FIG. 2) relative to a journey completion of the digital document.

To illustrate, the action recommendation system 106 utilizes the ensemble model 608 to determine the progress of the digital document and generates the dynamic weights 612 for the persona action recommendations 604 and the journey action recommendations 606 based on the progress. For instance, in some embodiments, the action recommendation system 106 weights the persona action recommendations 604 higher (or more heavily) at the start of an editing session of the digital document within the editing platform. In contrast, the action recommendation system 106 weights the journey action recommendations 606 lower (or less heavily) at the start of the editing session. To further illustrate, as the action recommendation system 106 determines that the editing session has progressed to near completion of the digital document, the action recommendation system 106 weights the persona action recommendations 604 lower and the journey action recommendations 606 higher.

Moreover, in some implementations, the action recommendation system 106 generates the dynamic weights 612 such that the weighting of the persona action recommendations 604 and the journey action recommendations 606 gradually changes throughout the editing session. In these or other embodiments, the action recommendation system 106 continuously lowers the weighting of the persona action recommendations 604 as more edits accumulate through the editing session. Conversely, the action recommendation system 106 continuously raises the weighting of the journey action recommendations 606 as more edits accumulate through the editing session.

As further illustrated in FIG. 6, in one or more embodiments, the action recommendation system 106 generates the selected action recommendations 614 based on the ideal ranking weights and the dynamic weights. Specifically, the ensemble model 608 utilizes the ideal ranking weights 610 and the dynamic weights 612 to determine the selected action recommendations 614. Furthermore, in one or more implementations, the action recommendation system 106 determines the selected action recommendations 614 from the context action recommendations 602, the persona action recommendations 604, and/or the journey action recommendations 606.

To illustrate, in some embodiments, the action recommendation system 106 determines the selected action recommendations to include a set of context action recommendations 602, a set of persona action recommendations 604, or a set of journey action recommendations 606. Alternatively, the action recommendation system 106 determines the selected action recommendations 614 to include a mix of action recommendations from at least two of the context action recommendations 602, the persona action recommendations 604, and the journey action recommendations 606. In further embodiments, the action recommendation system 106 determines, for a given time, that the selected action recommendations 614 include a subset of action recommendations from only one of the context action recommendations 602, the persona action recommendations 604, and the journey action recommendations 606 after evaluating the action recommendations from the different models using the ensemble model 608.

As additionally shown in FIG. 6, in some implementations, the action recommendation system 106 generates the selected action recommendations 614 in real time. In particular, the action recommendation system 106 updates the context action recommendations 602 in response to detecting the performance of an editing action. For example, if the action recommendation system 106 detects the performance of an action corresponding to the selected action recommendations 614, the action recommendation system 106 updates the context action recommendations 602 by updating the prior action history as discussed above with respect to FIG. 3.

Additionally, in these or other implementations, the action recommendation system 106 proceeds to update the selected action recommendations 614 using the ensemble model 608 as described above. Indeed, in these or other embodiments, the action recommendation system 106 updates the selected action recommendations 614 in real time in response to detecting performed actions throughout the editing journey.

As previously noted, in one or more embodiments, the action recommendation system 106 determines selected action recommendations for display in an editing platform on a client device. Indeed, in one or more implementations, the action recommendation system 106 displays these selected action recommendations in a graphical user interface of the editing platform. FIG. 7 illustrates a diagram of the action recommendation system 106 displaying selected action recommendations in example graphical user interfaces in accordance with one or more embodiments.

As shown in FIG. 7, in some embodiments, the action recommendation system 106 provides the selected action recommendations 708a (e.g., selected action recommendations 212 or 614 of FIGS. 2 and 6, respectively) for display on a client device 702 (e.g., client device 208 of FIG. 2). Specifically, the action recommendation system 106 provides the selected action recommendations 708a for display within a graphical user interface 704 of the editing platform. For example, the action recommendation system 106 provides the selected action recommendations 708a within the graphical user interface 704 also including (or displaying) the digital document 706.

As mentioned above, and as further illustrated in FIG. 7, in some implementations, the action recommendation system 106 the displays a particular set of selected action recommendations such as selected action recommendations 708a based on the canvas content displayed on the graphical user interface 704. To illustrate, the action recommendation system 106 determines that the canvas content includes a background 710, a text object 712, and an image 714 of the digital document. In this example, none of the canvas content items such as the background 710, the text object 712, or the image 714 are selected but are merely available for selection. In this example, the action recommendation system 106 determines, utilizing the machine learning models as described above with respect to FIGS. 2-6, that the selected action recommendations 708a include editing actions such as “replace image,” “edit text,” and “change background.”

As also depicted in FIG. 7, in one or more embodiments, the action recommendation system 106 displays a new set of selected action recommendations 708b (e.g., including editing actions “replace image,” “apply effects,” “adjust opacity”, crop, and remove). In particular, the action recommendation system 106 provides the new selected action recommendations 708b based on a performed action. For example, in one or more implementations, when the action recommendation system 106 detects the performance of an editing action (e.g., an action corresponding to the selected action recommendations 708a) the action recommendation system 106 updates the graphical user interface 704 to display the new selected action recommendations 708b. To illustrate, in some embodiments, the action recommendation system 106 detects a performed action such as changing the background 710 and displays the new selected action recommendations 708b.

As further illustrated in FIG. 7, in some implementations, the action recommendation system 106 displays the selected action recommendations 708a and 708b as interactive graphical elements within the graphical user interface 704. Specifically, the action recommendation system 106 displays each recommended action of the selected action recommendations 708a and 708b as individual interactive graphical elements. For example, the action recommendation system 106 displays each of “replace image”, “edit text”, and “change background” as an individual interactive graphical element. In these or other embodiments, in response to user interaction with one of the interactive graphical elements of the selected action recommendations 708a and 708b, the action recommendation system 106 performs the corresponding action or displays the corresponding tool(s) for performing the action within the editing platform.

Further, in these or other embodiments, the action recommendation system 106 displays the corresponding set of tools without requiring further user interactions or user interfaces to drill down through menu items to reach the corresponding set of tools. Indeed, by providing the selected action recommendations 708a or 708b as interactive graphical elements, the action recommendation system 106 reduces the number of user interactions and/or user interfaces required to perform actions within the editing platform. Similarly, the action recommendation system 106 updates selected action recommendations even in response to selections of menu items or tools outside of the selected action recommendations, maintaining a dynamic set of action recommendations based on any actions performed within the editing platform.

To illustrate, in response to a user interaction with the “apply effects” action element of the selected action recommendations 708b, the action recommendation system 106 displays a menu of effects that the action recommendation system 106 applies to the digital document or an object of the digital document such as the image 714. Indeed, the action recommendation system 106 displays the menu of effects without requiring additional user interactions or interfaces to access this menu of effects.

To illustrate further, the action recommendation system 106 displays the new selected action recommendations 708b based on an action such as a selection of one of the available objects of the canvas content. To illustrate, in response to determining a selection of the image 714 as indicated by the selection indicator 716, the action recommendation system 106 replaces the selected action recommendations 708a with the new selected action recommendations 708b. In these or other embodiments, the action recommendation system 106 determines the new selected action recommendations 708b utilizing the machine learning models as described above with respect to FIGS. 2-6.

Turning to FIG. 8, additional detail will now be provided regarding various components and capabilities of the action recommendation system 106. In particular, FIG. 8 illustrates an example schematic diagram of a computing device 800 (e.g., the server device(s) 102 and/or the client device(s) 110 of FIG. 1) implementing the action recommendation system 106 in accordance with one or more embodiments of the present disclosure for components 800-808. As illustrated in FIG. 8, the action recommendation system 106 includes an action recommendation manager 802, a weights generator 804, a selected actions manager 806, and a storage manager 808.

The action recommendation manager 802 utilizes machine learning models to generate action recommendations for editing a digital document. In particular, the action recommendation manager 802 accesses data from a user account and the digital document being edited. Moreover, the action recommendation manager 802 utilizes a context aware neural network to generate context action recommendations based on the context of the digital document. Furthermore, the action recommendation manager 802 utilizes a persona model to generate persona action recommendations based on user specific data of the user account editing the digital document. Additionally, the action recommendation manager utilizes a journey model to generate journey action recommendations related to a successful journey for editing the digital document. Further, the action recommendation manager 802 interacts with other components to pass the context, persona, and journey action recommendations for further processing.

Moreover, the weights generator 804 determines selected action recommendations for display on a client device. Specifically, the weights generator 804 accesses an ensemble model 114 to determine the selected action recommendations from the context, persona, and journey action recommendations. For instance, the weights generator 804 determines the selected action recommendations using the ensemble model 114 by determining sets of weights for the context, persona, and journey action recommendations. In particular, the weights generator 804 determines the sets of weights by comparing the context, persona, and journey action recommendations to an ideal ranking. Furthermore, the weights generator 804 interacts with other components to pass selected action recommendations for further processing.

Additionally, the selected actions manager 806 provides the selected action recommendations for display on a client device. Specifically, the selected actions manager 806 provides the selected action recommendations as interactive graphical elements within a graphical user interface. For example, the selected actions manager 806 provides the selected action recommendations within the graphical user interface which includes (or also displays) the digital document.

Further, as shown in FIG. 8, the action recommendation system 106 includes a storage manager 808. In one or more implementations, the storage manager 808 stores information (e.g., via one or more memory devices) on behalf of the action recommendation system 106. For example, the storage manager 808 includes a database for storing user account data, digital document data, n-grams, context action recommendations, user persona information, relevant edits related to a user account, persona action recommendations, decision trees, journey action recommendations, and selected action recommendations.

In one or more embodiments, each of the components 802-808 of the action recommendation system 106 include software, hardware, or both. For example, the components 802-808 include one or more instructions stored on a computer-readable storage medium and executable by processors of one or more computing devices, such as a client device or server device. When executed by the one or more processors, the computer-executable instructions of the action recommendation system 106 cause the computing device(s) to perform the methods described herein. Alternatively, the components 802-808 include hardware, such as a special-purpose processing device to perform a certain function or group of functions. Alternatively, the components 802-808 of the action recommendation system 106 include a combination of computer-executable instructions and hardware.

Furthermore, the components 802-808 of the action recommendation system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 802-808 of the action recommendation system 106 are implemented as a stand-alone application, such as a desktop or mobile application. Furthermore, in various embodiments, the components 802-808 of the action recommendation system 106 are implemented as one or more web-based applications hosted on a remote server. Alternatively, or additionally, the components 802-808 of the action recommendation system 106 are implemented in a suite of mobile device applications or “apps.” For example, in one or more embodiments, the action recommendation system 106 comprises or operates in connection with digital software applications such as ADOBE® CREATIVE CLOUD® or ADOBE® EXPRESS®.

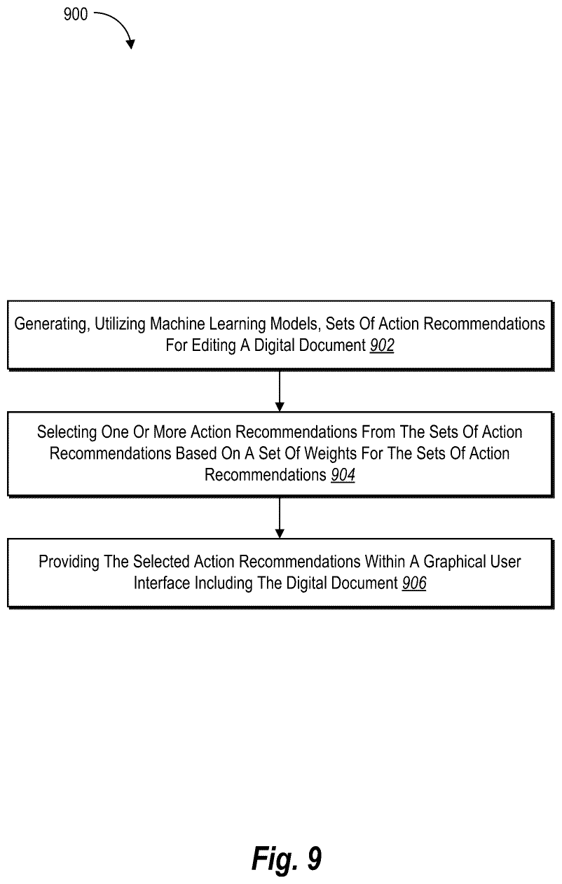

FIGS. 1-8, the corresponding text, and the examples provide a number of different systems, methods, and non-transitory computer readable media for generating machine-learning based action recommendations for display on a client device via an ensemble model. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to some embodiments, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 for generating machine-learning based action recommendations for display on a client device in accordance with one or more embodiments. The series of acts 900 can include an act 902 of generating, utilizing machine learning models, sets of action recommendations for editing a digital document; an act 904 of selecting one or more action recommendations from the sets of action recommendations based on a set of weights for the sets of action recommendations; and an act 906 of providing the selected action recommendations within a graphical user interface including the digital document.

In some embodiments, the act 902 includes generating, utilizing a context aware neural network, a first set of action recommendations for editing a digital document based on contextual data from content of the digital document. In some embodiments, the act 902 also includes an act of generating, utilizing a user persona model, a second set of action recommendations for editing the digital document based on user specific data of a user account editing the digital document. In some implementations, the act 904 further includes an act of determining, utilizing an ensemble model, one or more selected action recommendations from the first set of action recommendations or the second set of action recommendations based on weights assigned to the first set of action recommendations and the second set of action recommendations. Additionally, in one or more embodiments, the act 906 includes an act of providing, for display on a client device, the one or more selected action recommendations within a graphical user interface including the digital document.

In some implementations, the series of acts 900 includes generating, utilizing the context aware neural network, the first set of action recommendations for editing the digital document based on a project type of the digital document. In one or more embodiments, the series of acts 900 includes generating, utilizing the context aware neural network, the first set of action recommendations for editing the digital document based on an action history of edits to the digital document.

In one or more implementations, generating the first set of action recommendations for editing the digital document based on the action history of edits to the digital document includes determining a sequence of events including prior actions performed in the digital document. In one or more implementations, the series of acts 900 also includes an act of generating n-grams from the prior actions performed in the digital document. In some embodiments, the series of acts 900 further includes an act of generating, utilizing the context aware neural network, the first set of action recommendations for editing the digital document based on the n-grams.

In some embodiments, generating, utilizing the context aware neural network, the first set of action recommendations for editing the digital document based on the contextual data from the content of the digital document includes generating the first set of action recommendations based on a content of a canvas of the digital document. In some implementations, generating, utilizing the user persona model, the second set of action recommendations for editing the digital document based on the user specific data of the user account editing the digital document includes generating the second set of action recommendations based on a user persona of the user account, the user persona indicating a category of project types associated with the user account.

In one or more embodiments, generating, utilizing the user persona model, the second set of action recommendations for editing the digital document based on the user specific data of the user account editing the digital document includes generating the second set of action recommendations based on a set of edits relevant to the user account according to a user account project history. In one or more implementations, the series of acts 900 includes generating, utilizing a journey model, a third set of action recommendations related to a successful journey for editing the digital document within an editing platform by determining a journey starting point based on an initial action performed in the digital document. Additionally, in some implementations, the series of acts 900 includes an act of determining, utilizing a decision tree model, a successful journey pathway of actions based on the journey starting point.

In some embodiments, the act 902 includes generating, utilizing a plurality of machine learning models, a plurality of action recommendations for editing a digital document including two or more of a first set of action recommendations based on a context of the digital document. In one or more embodiments, the act 902 also includes an act of a second set of action recommendations based on user specific data of a user account editing the digital document. In one or more implementations, the act 902 further includes an act of or a third set of action recommendations related to a successful journey for editing the digital document within an editing platform. Additionally, in some embodiments, the act 904 includes an act of selecting, utilizing an ensemble model, one or more action recommendations from the plurality of action recommendations based on a set of weights for the plurality of action recommendations determined by comparing the plurality of action recommendations to an ideal ranking. In some implementations, the act 906 also includes an act of providing, for display on a client device, the one or more selected action recommendations as interactive graphical elements within a graphical user interface including the digital document.

In some implementations, the series of acts 900 includes selecting, utilizing the ensemble model, the one or more action recommendations from the plurality of action recommendations based on a second set of weights for the second set of action recommendations and the third set of action recommendations by determining progress of the digital document relative to a journey completion of the digital document. In one or more embodiments, the series of acts 900 includes generating the first set of action recommendations based on the context of the digital document by determining a sequence of prior actions performed on the digital document. In one or more embodiments, the series of acts 900 further includes an act of generating, utilizing a context aware neural network, the first set of action recommendations based on the sequence of prior actions performed on the digital document.

In one or more implementations, the series of acts 900 includes generating the first set of action recommendations based on the context of the digital document by determining at least one of a selected object or an available object on a canvas of the digital document. In some embodiments, the series of acts 900 includes generating the second set of action recommendations based on the user specific data of the user account editing the digital document by at least one of determining a user persona of the user account editing the digital document, the user persona indicating a category of project types associated with the user account. Additionally, in one or more implementations, the series of acts 900 includes an act of or determining a set of edits most relevant to the user account according to a user account project history.

In some implementations, the series of acts 900 includes generating, utilizing a user persona model, the second set of action recommendations based on at least one of the user persona. In some embodiments, the series of acts 900 also includes an act of or the set of edits most relevant to the user account as determined by a singular value decomposition model utilizing the user account project history within a matrix structure.

In one or more embodiments, the series of acts 900 includes generating the third set of action recommendations related to the successful journey for editing the digital document within the editing platform by determining, for the user account editing the digital document, a tenure with the editing platform. In some implementations, the series of acts 900 further includes an act of determining a journey starting point of the user account editing the digital document. Additionally, in one or more embodiments, the series of acts 900 includes an act of generating, utilizing a journey model, the third set of action recommendations based on the tenure of the user account and the journey starting point.

In one or more implementations, the act 902 includes generating, utilizing a context aware neural network, a first set of action recommendations for editing a digital document based on contextual data from content of the digital document. In one or more implementations, the act 902 also includes an act of generating, utilizing a user persona model, a second set of action recommendations for editing the digital document based on user specific data of a user account editing the digital document. In some embodiments, the act 904 further includes an act of determining, utilizing an ensemble model, one or more selected action recommendations from the first set of action recommendations or the second set of action recommendations based on weights assigned to the first set of action recommendations and the second set of action recommendations. Additionally, in some implementations, the act 906 includes an act of providing, for display on a client device, the one or more selected action recommendations within a graphical user interface including the digital document.

In some embodiments, the series of acts 900 includes detecting a performance of an action corresponding to the one or more selected action recommendations on the client device. In one or more embodiments, the series of acts 900 also includes an act of providing, for display on the client device, an additional one or more selected action recommendations within the graphical user interface including the digital document based on the performed action. In some implementations, the series of acts 900 includes generating the first set of action recommendations for editing the digital document based on the contextual data from the content of the digital document includes determining at least one of a selected object or an available object on a canvas of the digital document. In one or more implementations, the series of acts 900 further includes an act of generating, utilizing the context aware neural network, the first set of action recommendations based on the at least one of the selected object or the available object.

In one or more embodiments, the series of acts 900 includes generating, utilizing a journey model, a third set of action recommendations related to a successful journey for editing the digital document within an editing platform based on a purpose of the digital document determined based on a primary medium included in the digital document or a content type of the digital document. In one or more implementations, the series of acts 900 includes determining the weights assigned to the first set of action recommendations and the second set of action recommendations by comparing the first set of action recommendations and the second set of action recommendations to an ideal ranking of the first set of action recommendations and the second set of action recommendations sorted in descending order of relevance according to a ground truth.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device 800 of FIG. 8, the client device(s) 110 of FIG. 1, and/or the server device(s) 102 of FIG. 1) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
generating, utilizing a context aware neural network, a first set of action recommendations for editing a digital document based on contextual data from content of the digital document;
generating, utilizing a user persona model, a second set of action recommendations for editing the digital document based on user specific data of a user account editing the digital document;
determining, utilizing an ensemble model, one or more selected action recommendations from the first set of action recommendations or the second set of action recommendations based on weights assigned to the first set of action recommendations and the second set of action recommendations; and
providing, for display on a client device, the one or more selected action recommendations within a graphical user interface including the digital document.

2. The computer-implemented method of claim 1, further comprising generating, utilizing the context aware neural network, the first set of action recommendations for editing the digital document based on a project type of the digital document.

3. The computer-implemented method of claim 1, further comprising generating, utilizing the context aware neural network, the first set of action recommendations for editing the digital document based on an action history of edits to the digital document.

4. The computer-implemented method of claim 3, wherein generating the first set of action recommendations for editing the digital document based on the action history of edits to the digital document comprises:
determining a sequence of events comprising prior actions performed in the digital document;
generating n-grams from the prior actions performed in the digital document; and
generating, utilizing the context aware neural network, the first set of action recommendations for editing the digital document based on the n-grams.

5. The computer-implemented method of claim 1, wherein generating, utilizing the context aware neural network, the first set of action recommendations for editing the digital document based on the contextual data from the content of the digital document comprises generating the first set of action recommendations based on a content of a canvas of the digital document.

6. The computer-implemented method of claim 1, wherein generating, utilizing the user persona model, the second set of action recommendations for editing the digital document based on the user specific data of the user account editing the digital document comprises generating the second set of action recommendations based on a user persona of the user account, the user persona indicating a category of project types associated with the user account.

7. The computer-implemented method of claim 1, wherein generating, utilizing the user persona model, the second set of action recommendations for editing the digital document based on the user specific data of the user account editing the digital document comprises generating the second set of action recommendations based on a set of edits relevant to the user account according to a user account project history.

8. The computer-implemented method of claim 1, further comprising generating, utilizing a journey model, a third set of action recommendations related to a successful journey for editing the digital document within an editing platform by:
determining a journey starting point based on an initial action performed in the digital document; and
determining, utilizing a decision tree model, a successful journey pathway of actions based on the journey starting point.

9. A system comprising:
one or more memory devices; and
one or more processor devices coupled to the one or more memory devices that cause the system to perform operations comprising:
generating, utilizing a plurality of machine learning models, a plurality of action recommendations for editing a digital document comprising two or more of:
a first set of action recommendations based on a context of the digital document;
a second set of action recommendations based on user specific data of a user account editing the digital document; or
a third set of action recommendations related to a successful journey for editing the digital document within an editing platform;
selecting, utilizing an ensemble model, one or more action recommendations from the plurality of action recommendations based on a set of weights for the plurality of action recommendations determined by comparing the plurality of action recommendations to an ideal ranking; and
providing, for display on a client device, the one or more selected action recommendations as interactive graphical elements within a graphical user interface including the digital document.

10. The system of claim 9, wherein the one or more processor devices are further configured to select, utilizing the ensemble model, the one or more action recommendations from the plurality of action recommendations based on a second set of weights for the second set of action recommendations and the third set of action recommendations by determining progress of the digital document relative to a journey completion of the digital document.

11. The system of claim 9, wherein the one or more processor devices are further configured to generate the first set of action recommendations based on the context of the digital document by:
determining a sequence of prior actions performed on the digital document; and
generating, utilizing a context aware neural network, the first set of action recommendations based on the sequence of prior actions performed on the digital document.

12. The system of claim 9, wherein the one or more processor devices are further configured to generate the first set of action recommendations based on the context of the digital document by determining at least one of a selected object or an available object on a canvas of the digital document.

13. The system of claim 9, wherein the one or more processor devices are further configured to generate the second set of action recommendations based on the user specific data of the user account editing the digital document by at least one of:
determining a user persona of the user account editing the digital document, the user persona indicating a category of project types associated with the user account; or
determining a set of edits most relevant to the user account according to a user account project history.

14. The system of claim 13, wherein the one or more processor devices are further configured to generate, utilizing a user persona model, the second set of action recommendations based on at least one of:
the user persona; or
the set of edits most relevant to the user account as determined by a singular value decomposition model utilizing the user account project history within a matrix structure.

15. The system of claim 9, wherein the one or more processor devices are further configured to generate the third set of action recommendations related to the successful journey for editing the digital document within the editing platform by:
determining, for the user account editing the digital document, a tenure with the editing platform;
determining a journey starting point of the user account editing the digital document; and
generating, utilizing a journey model, the third set of action recommendations based on the tenure of the user account and the journey starting point.

16. A non-transitory computer-readable medium storing instructions thereon that, when executed by at least one processor device, cause the at least one processor device to perform operations comprising:
generating, utilizing a context aware neural network, a first set of action recommendations for editing a digital document based on contextual data from content of the digital document;
generating, utilizing a user persona model, a second set of action recommendations for editing the digital document based on user specific data of a user account editing the digital document;
determining, utilizing an ensemble model, one or more selected action recommendations from the first set of action recommendations or the second set of action recommendations based on weights assigned to the first set of action recommendations and the second set of action recommendations; and
providing, for display on a client device, the one or more selected action recommendations within a graphical user interface including the digital document.

17. The non-transitory computer-readable medium of claim 16, wherein the operations further comprise:
detecting a performance of an action corresponding to the one or more selected action recommendations on the client device; and
providing, for display on the client device, an additional one or more selected action recommendations within the graphical user interface including the digital document based on the performed action.

18. The non-transitory computer-readable medium of claim 16, wherein generating the first set of action recommendations for editing the digital document based on the contextual data from the content of the digital document comprises:
determining at least one of a selected object or an available object on a canvas of the digital document; and
generating, utilizing the context aware neural network, the first set of action recommendations based on the at least one of the selected object or the available object.

19. The non-transitory computer-readable medium of claim 16, wherein the operations further comprise generating, utilizing a journey model, a third set of action recommendations related to a successful journey for editing the digital document within an editing platform based on a purpose of the digital document determined based on a primary medium included in the digital document or a content type of the digital document.

20. The non-transitory computer-readable medium of claim 18, wherein the operations further comprise determining the weights assigned to the first set of action recommendations and the second set of action recommendations by comparing the first set of action recommendations and the second set of action recommendations to an ideal ranking of the first set of action recommendations and the second set of action recommendations sorted in descending order of relevance according to a ground truth.
